(19) United States
(12) Patent Application Publication
(10) Pub. No.: US 2010/0325604 A1
(43) Pub. Date: Dec. 23, 2010

(54) SYSTEM AND METHOD FOR PERFORMING COST ESTIMATION IN A SERVICE PROVIDER ENVIRONMENT

(75) Inventors: Cyndi C. Jones, Olathe, KS (US); Kathee Glodowski, Peculiar, MO (US); Bernadette Hurst, Altamonte Springs, FL (US); Chuck Irvine, Overland Park, KS (US); Merle C. Pell, North Port, FL (US); Guy Bower, Avon Park, FL (US); Steve Mosley, Fern Park, FL (US); Sebastian Chlopecki, Shawnee, KS (US)

Correspondence Address: SNR DENTON US LLP, P.O. BOX 061080, CHICAGO, IL, 60606-1080, US

(73) Assignee: EMBARQ HOLDINGS COMPANY, LLC

(21) Appl. No.: 12/489,021

(22) Filed: Jun. 22, 2009

(51) Int. Cl. G06F 9/44

(52) U.S. Cl. 717/105

(57) ABSTRACT

A system and method for providing cost estimation in performing a work project on communications infrastructure may include accessing a first data record generated by a first software tool, where the first data record includes data that specifies a work project on communications infrastructure. A second data record utilized by a second software tool may be populated utilizing the data of the first data record. A data set that is related to a combination of a first data element and a second data element of the first data record may be accessed. Using the second software tool, the data set may be presented to a user in a selectable format to enable the user to select a third data element from the presented data set, where the third data element may be used to estimate a cost for performing the work project. A cost estimate based on the third data element may be generated and presented to the user using the second software tool.

### BACKGROUND

Service providers, such as telecommunications service providers, are tasked with maintaining infrastructure to ensure their customers are capable of utilizing the infrastructure. In providing the telecommunication services, the telecommunications service provider must maintain telecommunication infrastructure, such as telephone poles, underground cables, network switches, and other communications equipment. Service providers are often staffed with field engineers and technicians for assigning, installing, and maintaining the infrastructure. However, while service providers maintain a certain level of staffing, service providers typically outsource work to local contractors that cannot be handled by the service providers. As understood, different regions of the country command different prices and rates for material and services.

One difficulty that service providers have is the ability to efficiently estimate cost for performing jobs to install and maintain the infrastructure. The typical way of performing cost estimations is in a highly manual manner. While different groups within the service provider may utilize computers that execute software that allow for material and labor (cost) estimates, the ability to integrate different groups within a service provider and control changes in billing operations is limited. As a result of existing cost estimation systems being so manual, inefficiencies naturally occur. Through auditing, a moderately sized telecommunications service provider has been able to identify millions of dollars of waste, fraud, and overpayments to deploy and maintain communications infrastructure. What is needed is an integrated and automated way to provide cost estimation for service providers.

### SUMMARY

To overcome the problems of cost estimation for service providers, the principles of the present invention provide for a system and method to integrate cost estimates for engineering design and field service of infrastructure to provide infrastructure for customer usage. The integrated system enables engineering to specify certain attributes of the infrastructure, such as location, material, and account type (e.g., capital, removal, maintenance) so that estimates can be made based on the attributes. In one embodiment, an engineer may utilize an engineering design tool, such as a computer aided design (CAD) tool or engineering work order (EWO) software tool, to both design or modify the infrastructure and specify the attributes. The attributes may include a task type (e.g., “remove,” “place,” “splice,” “modify,” etc.), labor codes (e.g., “45×,” “45C,” “45M1”), and, optionally, account codes to identify what account to apply the work order (e.g., capital, repair, removal) for each job task. The data generated by the engineer for each job task or work activity may be imported by a cost estimation tool to populate a table, thereby simplifying and reducing work to generate cost estimates. The attributes defined by the engineer may be used by the cost estimation tool to define selectable options for other parameters associated with each job task. In addition, negotiated contract terms for each contractor may be stored and utilized to accurately create cost estimates. In one embodiment, a job sheet that does not include proprietary information, such as cost estimates, may be generated for use by a field engineer or a contractor. Should any discrepancies be identified while performing a survey or job, a correction may be fed back to the engineer for revision to ensure that an invoice for the work activity matches the cost estimate.

One embodiment of a method for providing cost estimation in performing a work project on communications infrastructure may include accessing a first data record generated by a first software tool, where the first data record includes data that specifies a work project on communications infrastructure. A second data record utilized by a second software tool may be populated utilizing the data of the first data record. A data set that is related to a combination of a first data element and a second data element of the first data record may be accessed. Using the second software tool, the data set may be presented to a user in a selectable format to enable the user to select a third data element from the presented data set, where the third data element may be used to estimate a cost for performing the work project. A cost estimate based on the third data element may be generated and presented to the user using the second software tool.

One embodiment of a system for providing cost estimation in performing a work project on communications infrastructure may include (i) a first software tool configured to enable a first user to draw communications system infrastructure and create a first data record that includes attributes associated with the drawn communications system infrastructure, and (ii) a second software tool configured to import the first data record and populate a second data record. The second software tool may further be configured to enable a second user to select a data element from a data set that relates to first and second data elements of the first data record that is specified by the first user. The second software tool may further be configured to generate a cost estimate based on the selected data element and to present the cost estimate to the second user.

### BRIEF DESCRIPTION

Illustrative embodiments of the present invention are described in detail below with reference to the attached drawing figures, which are incorporated by reference herein and wherein:

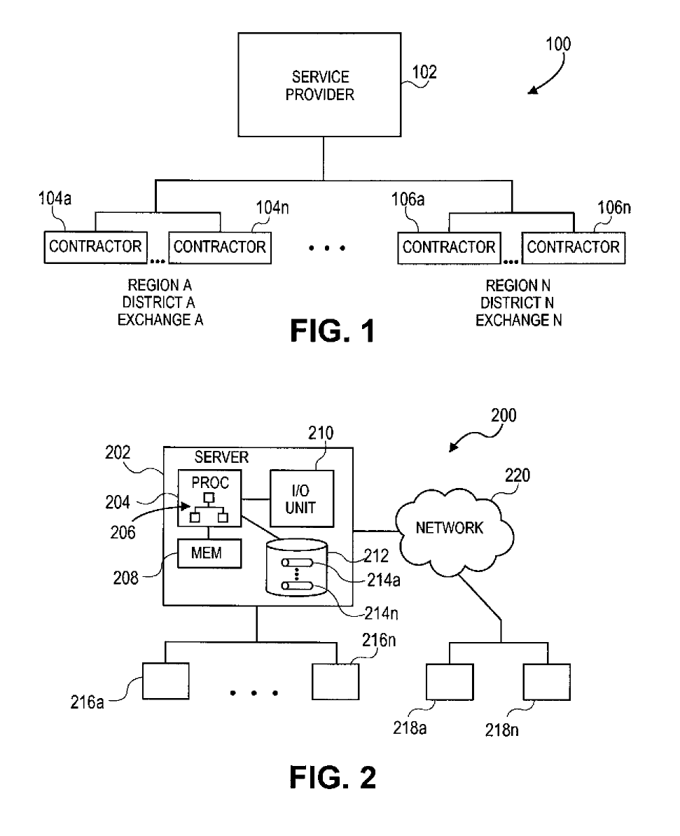

FIG. 1 is a block diagram of an illustrative service provider environment in which contractors perform work projects for a service provider;

FIG. 2 is an illustration of an illustrative network environment in which cost estimation in accordance with the principles of the present invention may be performed;

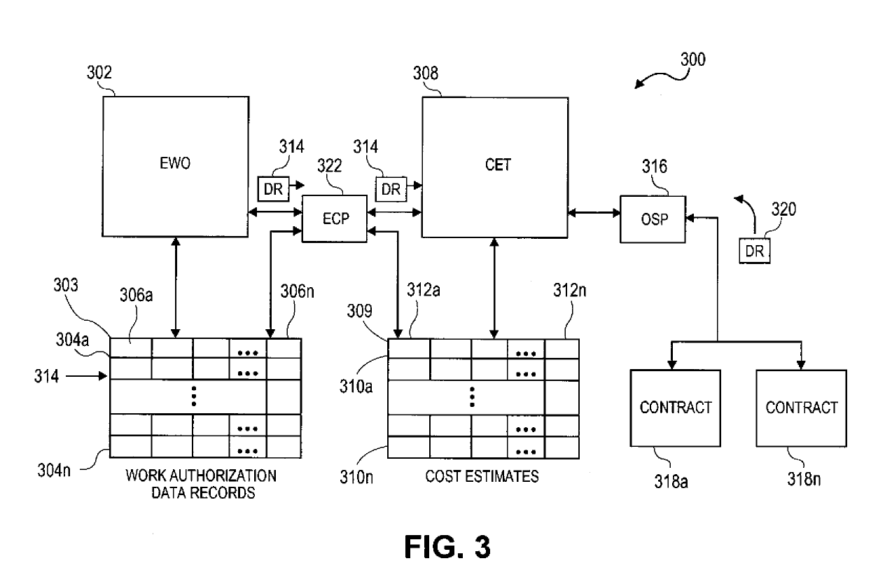

FIG. 3 is a block diagram of an illustrative software environment in which an engineer may create a work authorization and a cost estimate for that work authorization may be performed;

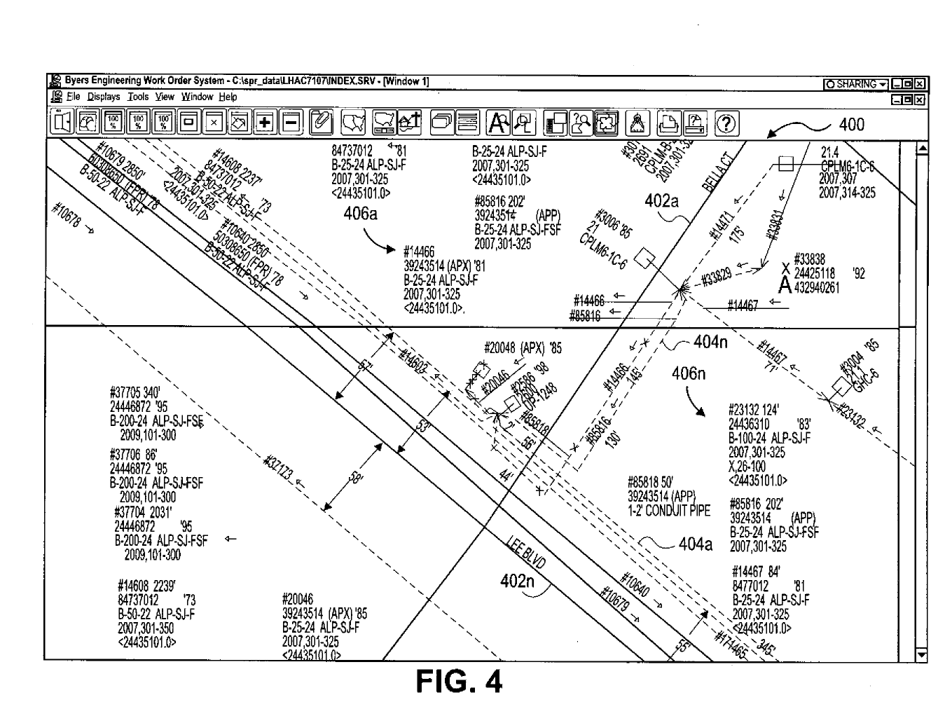

FIG. 4 is a screenshot of an illustrative map on which engineering work orders may be drawn and attributes may be applied by an engineer;

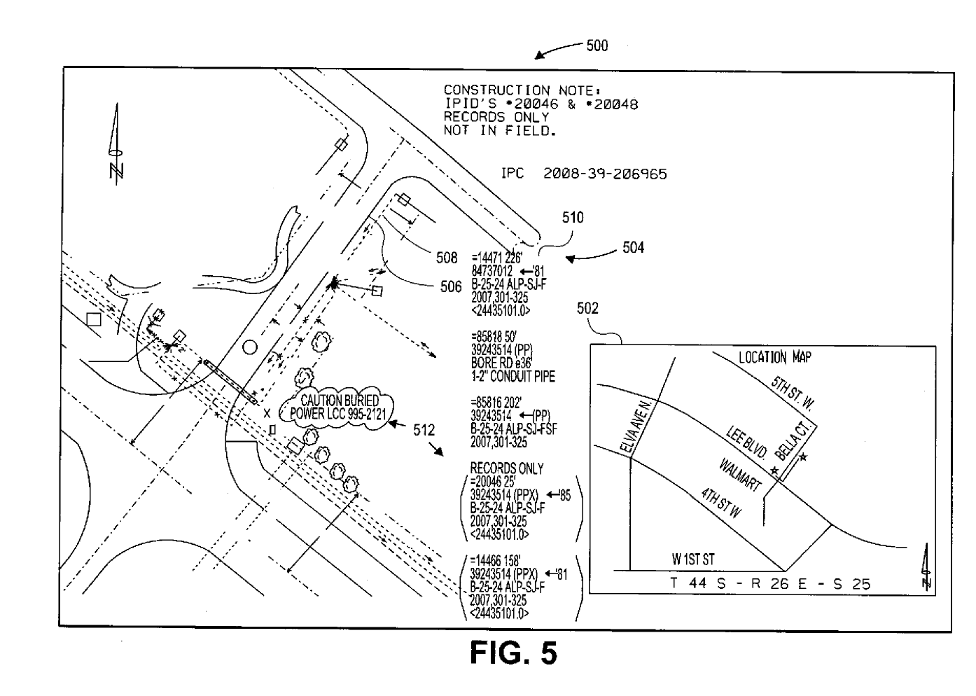

FIG. 5 is a screenshot of an illustrative construction map that may be utilized by a field engineer to execute an engineering work order;

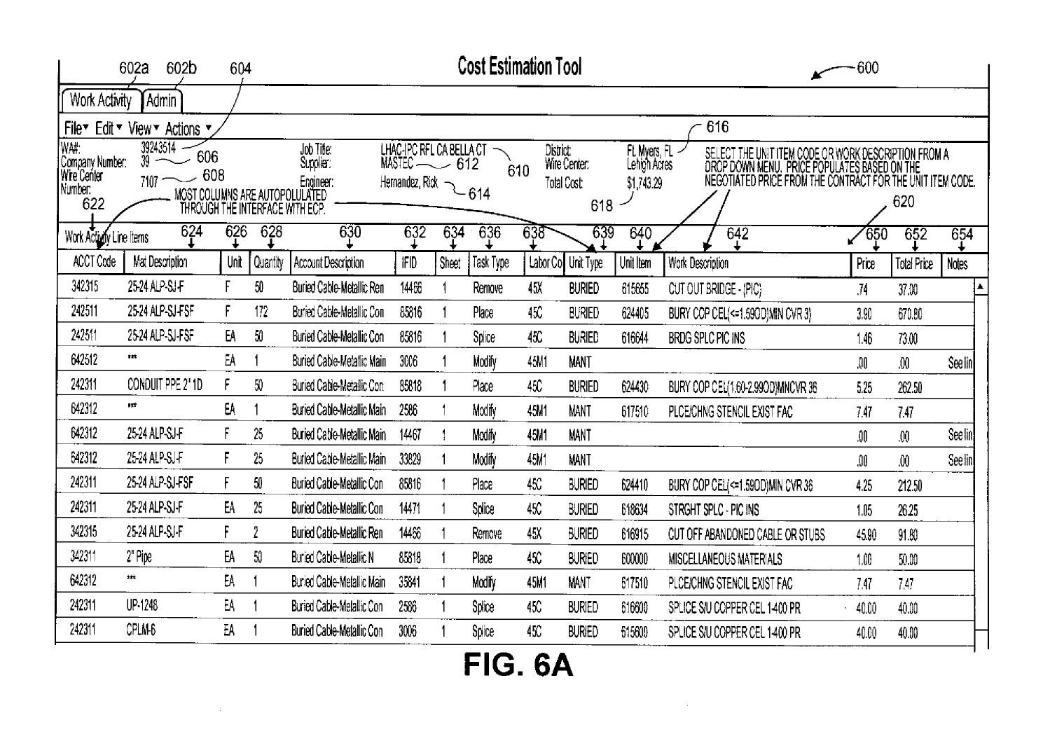

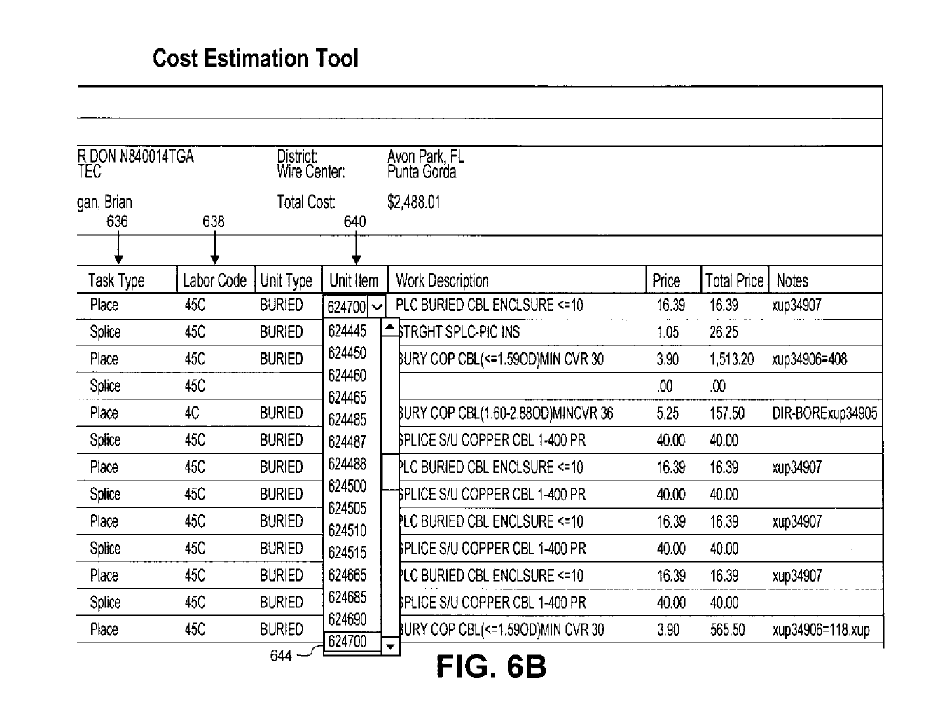

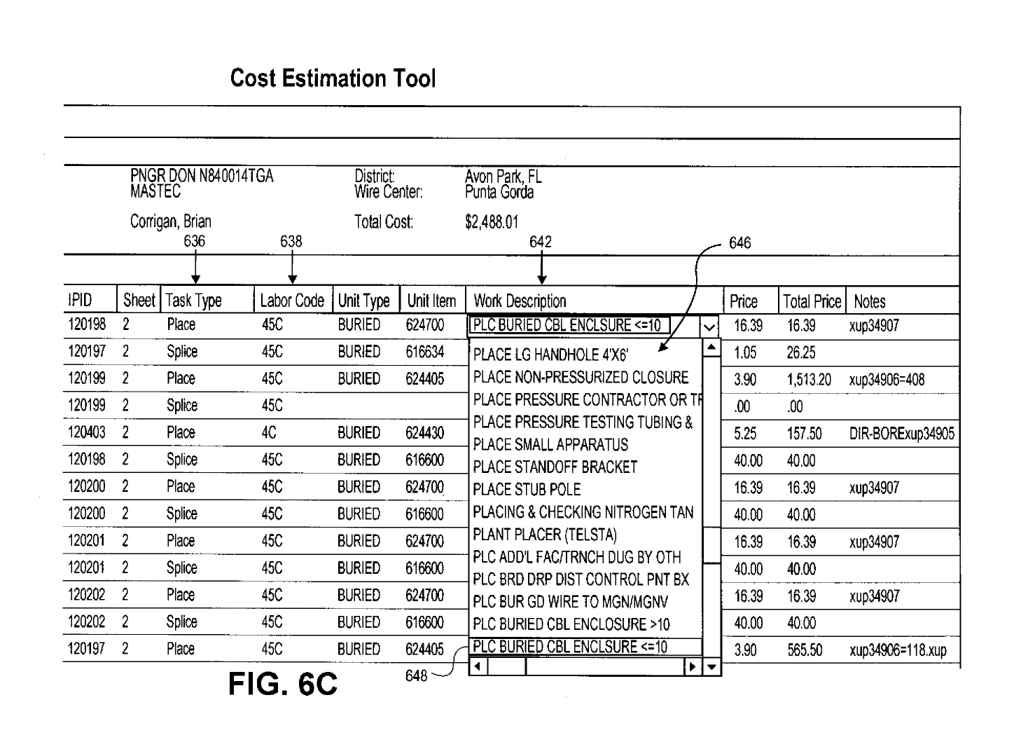

FIG. 6A is a screenshot of an illustrative graphical user interface generated by a cost estimation tool to enable a user to generate cost estimates for engineering work orders;

FIG. 6B is a screenshot of the graphical user interface of FIG. 6A showing an illustrative pull-down menu that enables a user to select a unit item associated with task type and labor code;

FIG. 6C is a screenshot of the graphical user interface of FIG. 6A showing a pull-down menu for a user to select a work description associated with a selected unit item;

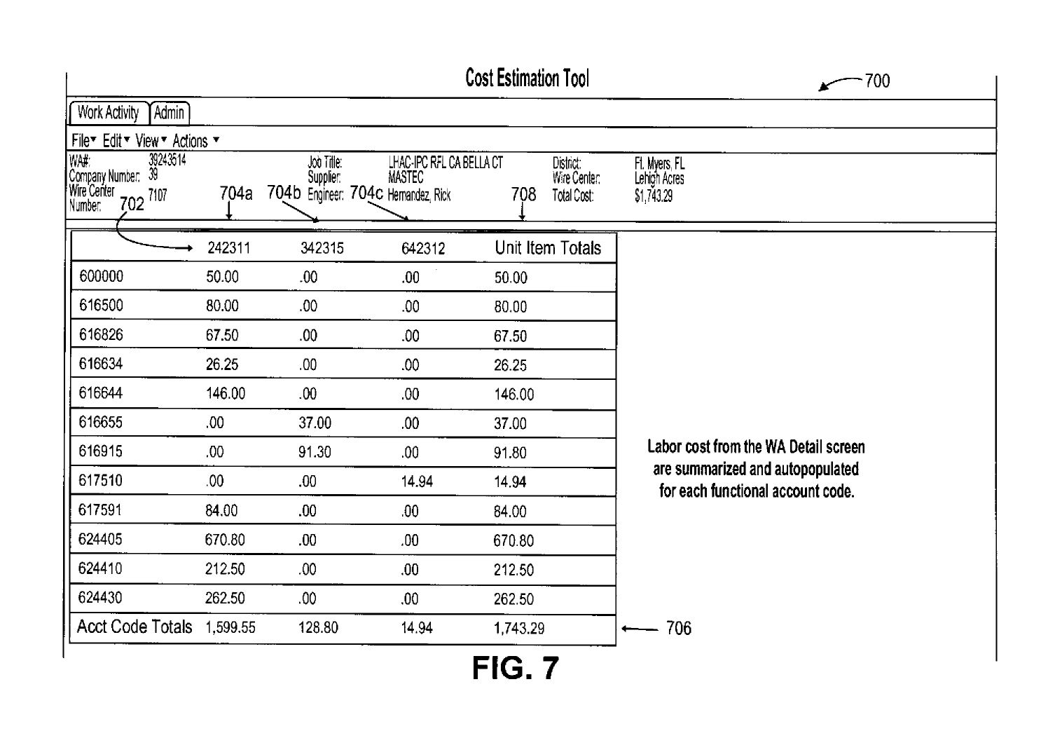

FIG. 7 is a screenshot of an illustrative graphical user interface showing account codes and cost estimates associated with engineering work orders in each of the account codes;

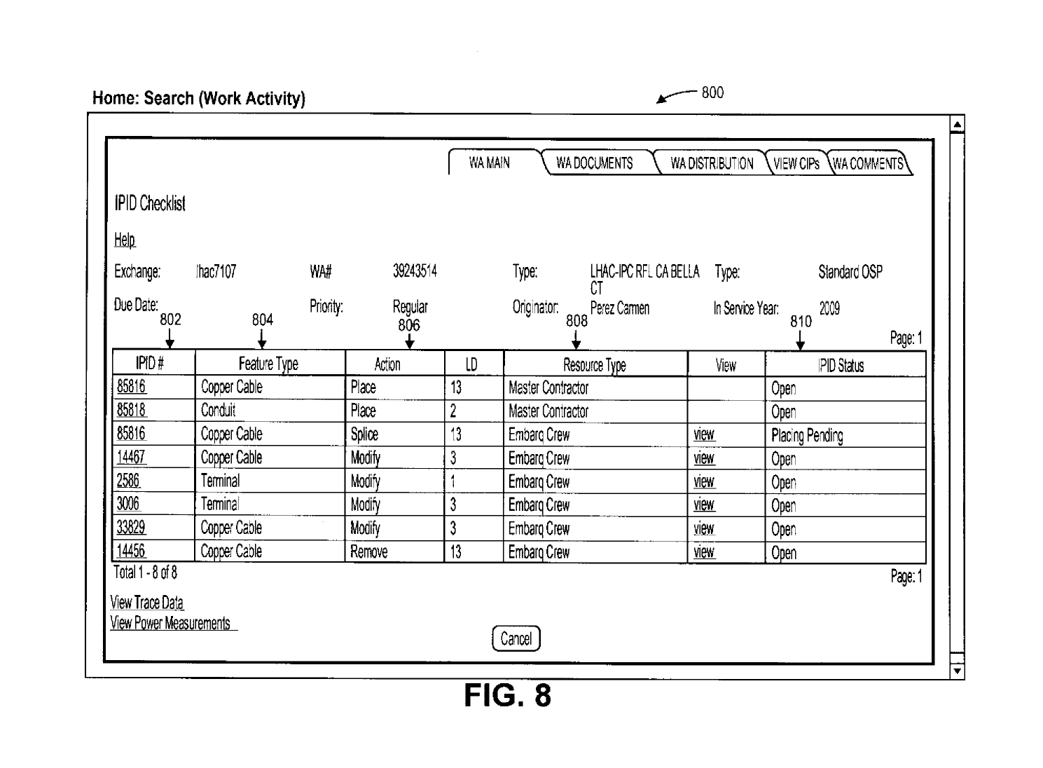

FIG. 8 is a screenshot of an illustrative graphical user interface of an engineering and construction portal for viewing status of particular engineering work orders;

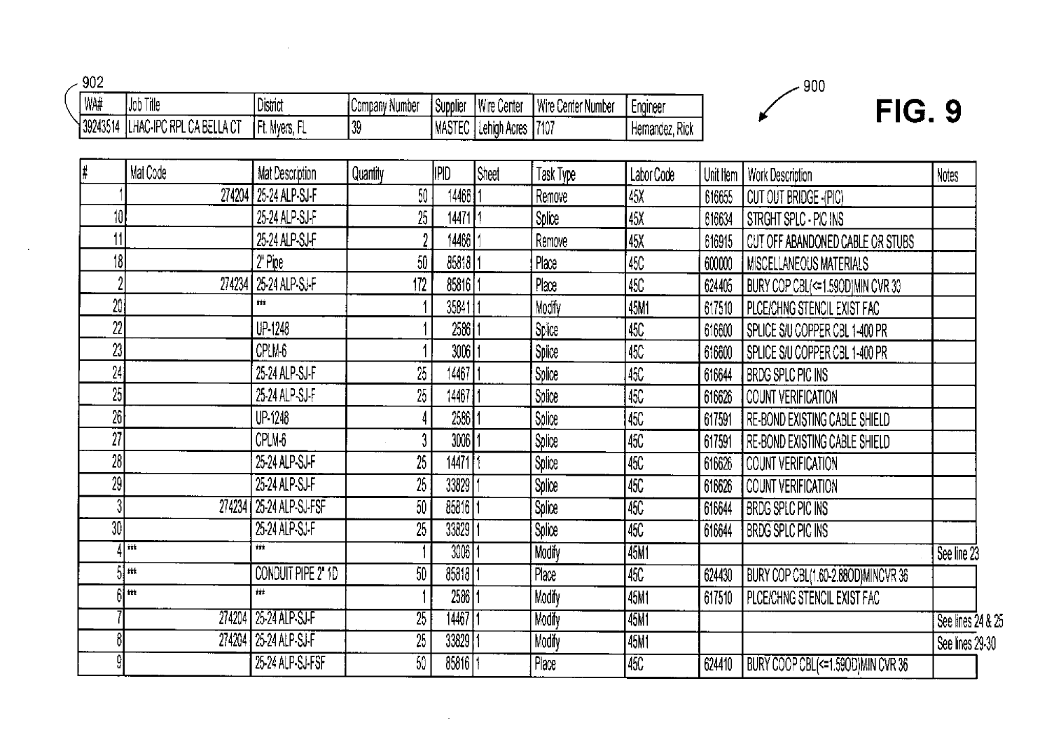

FIG. 9 is a screenshot of an illustrative Microsoft® Excel® table showing a work authorization for a particular company without any proprietary information, such as pricing; and

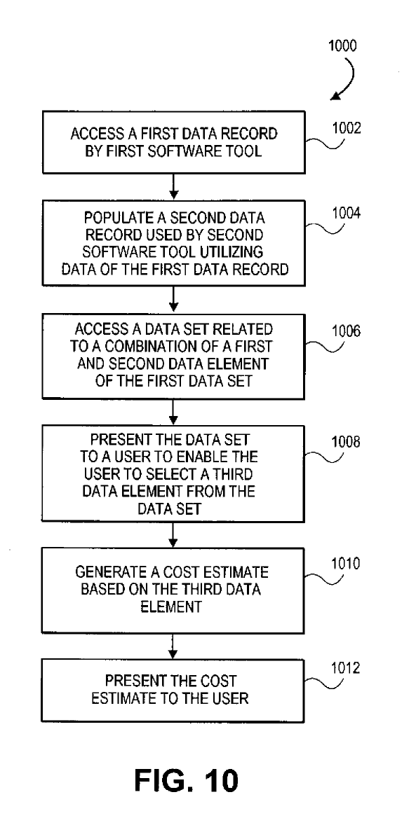

FIG. 10 is an illustrative flowchart for providing cost estimation for performing work projects for a communications service provider.

### DETAILED DESCRIPTION

With regard to FIG. 1, an illustrative service provider environment 100 includes a service provider 102 that utilizes contractors 104a-104n (collectively 104)-106a-106n (collectively 106). The contractors 104 may be in region A, district A, exchange A and contractors 106 may be in region N, district N, exchange N, where the regions, districts, and exchanges are in different locations throughout the country. As understood, contractors in one area of the country may have different rates from contractors in a different area of the country, even within districts the prices of contractors may vary for a variety of socioeconomic reasons. The service provider 102 may be a communications service provider, such as a wireline communications service provider, that uses contractors 104 and 106 to work on communications infrastructure, such as utility poles, cabling, switches, and any other communications infrastructure, as understood in the art. It should be understood, however, that the service provider 102 may be a communications service provider that works on different types of communications equipment, such as wireless communications equipment. Furthermore, the service provider 102 may be a service provider that works on other types of infrastructure, such as roadways, buildings, or any other physical infrastructure.

With regard to FIG. 2, an illustrative network environment 200 may include a server 202 that includes a processing unit 204 that executes software 206. The processing unit 204 may be configured with one or more computer processors that execute one or more software programs. The processing unit 204 may be in communication with a memory 208 that may store data and software, input/output (I/O) unit 210 that may provide for communication over one or more communications networks, and storage unit 212 that may be configured to store one or more data repositories 214a-214n (collectively 214). The data repositories 214 may be data files, databases, or any other configuration of data files. In one embodiment, computing devices 216a-216n (collectively 216) may be utilized by engineers of a service provider to generate engineering work orders by utilizing an engineering work order (EWO) software tool that enables the engineers to draw communications infrastructure components on a map (see FIG. 4), for example, to show communications infrastructure as related to physical objects, such as roadways or landmarks, and define attributes associated with the communications infrastructure that is being drawn. For example, an engineer interfacing with the server 202 via computing device 216a may draw a cable and define attributes associated with the cable, as further described with regard to FIG. 4.

Field engineers who work with the service provider may interface with the server 202 via computing devices 218a-218n (collectively 218) via communications network 220. In one embodiment, the communications network 220 may be a telecommunications network or data network, such as the Internet. The computing devices 218 may be laptop computers, handheld computers, desktop computers, or any other type of computer that enables an engineer to interface with the server 202 when working at a construction site. The software 206 may include an engineering and construction portal (ECP) through which the field engineers using the computing devices 218 access data stored in the data repositories 214, such as engineering work orders or otherwise.

With regard to FIG. 3, an illustrative software environment 300 may include an engineering work order (EWO) software tool 302 that may be utilized by an engineer to draw communications infrastructure on a map to add, delete, or modify communications infrastructure. The engineering work order software tool 302 may further be configured to enable an engineer to associate attributes with the communications infrastructure. The attributes may include name of components, part configurations (e.g., length, of cable, diameter of cable), account codes, geographic locations, labor code, and so on, as further described herein. Work authorization data records may be stored in table 303, where each of the rows 304a-304n are data records for each different work activity or authorization specified by an engineer using the engineering work order software tool 302, and each of the columns 306a-306n are data fields within each of the data records along the different rows 304a-304n. In one embodiment, a work authorization number may be different for each of the different data records in the rows 304a-304n. Alternatively, a single work activity may be composed of multiple line items, where each line item has its own row and multiple line items (i.e., rows) may be composed in the aggregate to form a single data record. For example, if there are 25 line items for a single work activity number, the same work activity number may be listed in 25 rows and each of those 25 rows are part of a single data record that is assigned to a supplier for performing the work project.

A cost estimation tool 308 may be a software tool that communicates indirectly or directly with the engineering work order software tool 302. The cost estimation tool 308 may communicate with a data table 309 that is part of a database or other data repository for storing cost estimates produced by the cost estimation tool 308. Similar to the data table 303, the data table 309 is formed of rows 310a-310n that define individual data records having data elements in different rows 312a-312n. The cost estimation tool 308 may receive a data, record 314 from the engineering work order software tool 302, where the data record 314 is a data record as stored in the data table 303. The data record 314 may be defined by a single row in the data table 303 or multiple rows in the data table 303, as previously described. The cost estimation tool 308 may utilize data in the data record 314 to display the data elements in the data record 314 to a user to enable the user to further select information for performing a work project and estimate cost for completing the work project (See FIG. 6).

An OSP pricing tool 316 may be utilized to enable a service provider to manage contracts 318a-318n (collectively 318) with suppliers and contractors that are used to perform work projects on communications infrastructure. The OSP pricing tool 316 may be the same or analogous to that described in co-pending U.S. patent application Ser. No. 11/290,390 filed on Nov. 30, 2005, which is incorporated by reference herein in its entirety. The contracts 318 have terms that are used to specify pricing for the contractors to perform certain job functions, such as splicing cable, removing cable, placing utility poles, and so on. The terms of the contracts 318 may be communicated in a data record 320 to the cost estimation tool 308 for use in estimating cost for performing a work project. The contract terms may be placed into data fields that are stored in the data table 309 and used in making the cost estimates. In one embodiment, the cost estimation tool 308 may enable a user to select which contractor to use and the terms specified in a contract of a contractor are accessed and utilized for making the cost estimate for the work project.

An engineering and construction portal (ECP) 322 is a software tool that may be utilized to enable field engineers or others to access data records in the data file 309 prepared by the cost estimation tool 308 and data records stored in the data file 303 created by the engineering work order software tool 302. The engineering and construction portal 322 may be the same or analogous to the one described in co-pending U.S. patent application Ser. No. 11/411,727 filed on Apr. 26, 2006, which is incorporated herein by reference in its entirety. The engineering and construction portal 322 may be accessible via a communications network, such as the Internet, and enables engineers to view non-proprietary data stored in the data records. In one embodiment, the engineering and construction portal 322 may operate as an interface between the engineering work order software tool 302 and cost estimation tool 308. The non-proprietary data records may be used in the field to work on work projects to repair, replace, install, or otherwise modify the communications infrastructure.

With regard to FIG. 4, a screenshot of an illustrative map 400 showing roadways 402a-n and, optionally, other geographic physical features, such as waterways, landmasses, and other physical features is shown. Communications infrastructure 404a-404n, such as cables, power lines, utility poles, or otherwise may also be shown and be marked relative to a physical feature, such as a roadway 402n. An engineer may draw the communications infrastructure and assign attributes 406a-406n to each of the respective communications infrastructure. For example, attributes of a communications line may include work authorization number, length, diameter, material description, account description, task type (e.g., remove, place, splice, modify), labor code that is selectable based on the task type and account code, and other information that may enable the engineer to specify particular information of communication infrastructure that will enable a field engineer to estimate cost and perform his or her job in working with the contractor to perform the work project. The attributes associated with each of the work authorizations may be saved to a data repository that may be accessible by a cost estimation tool for an engineer to complete a cost estimate and assign a particular contractor to perform the work project.

With regard to FIG. 5, a screenshot of an illustrative engineering map 500 may be created from the engineering work order system, as provided in FIG. 4. The engineering map 500 may show a location map 502, which is a smaller scale map to show generally where a work project in a detailed map 504 is physically occurring. The detailed map 504 may show a roadway 506 at which communications infrastructure 508 is physically positioned in relation thereto. The communications infrastructure 508 may be given a set of attributes, as previously described. One of the attributes may be a work authorization number (e.g., #14471) that uniquely identifies work to be associated with the communications infrastructure (e.g., placing a communications cable). A set of attributes 510 may be shown on the engineering map 504 to include a number of different attributes that may assist an engineer with determining what work projects are to be performed for the communications infrastructure 508. Additional notes 512 that are not used for cost estimate purposes may be listed on the engineering map 504 that may be helpful for different engineers and technicians to work on communications infrastructure shown on the engineering map 504.

With regard to FIG. 6A, a screenshot of an illustrative graphical user interface 600 provided by a cost estimation tool is shown. The graphical user interface (GUI) 600 includes multiple tabs 602a and 602b, where the graphical user interface 600 is showing a selection of a work activity page associated with the tab 602a. Work activity number 604 has been selected by a user, where the work activity number is associated with a data record produced by an engineering work order software tool, such as EWO 302 that shown in FIG. 3. Attributes associated with the work authorization number 604 may include company number 606, wire center number 608, where a wire center is a facility of a communications service provider that manages customer communications lines, job title 610, supplier or contractor 612 and engineer 614. A district wire center 616 and total cost 618 of the work authorization as estimated may also be provided.

In one embodiment, work authorization or work activity line items 620 may be listed in rows and columns. Each of the rows may be a line item and each of the columns may be data elements associated with each of the work activities. In one embodiment, the data elements of a data record include attributes defined by an engineer using the engineering work order software tool 302 (FIG. 3) may be populated in a data record of the cost estimation tool 308 (FIG. 3). Populating the data record of the cost estimation tool may be performed automatically by importing or loading the data record into the cost estimation tool, and data record(s) associated with a work authorization number 604 may be populated in respective data records and data fields, as shown in the line items 620. An account code 622 may be accounting codes that define what account a particular work activity is to be placed for accounting purposes. For example, the account codes may be a capital or asset account, expense account, or other type of account based on the type of work that the work activity is defined as being. For example, a cable that is to be installed may be assigned to a capital account, whereas a cable that is being fixed may be assigned to an expense account.

Material description data elements 624 may define specific material that communications infrastructure is to use. For example, the material description may define a specific part number for a particular cable. In addition, unit data elements 626 and quantity data elements 628 may be used to further define the amount of material, such as 50 feet of cable, which is to be used for the particular line item. Account description data elements 630 may provide a written description of the material descriptions for the respective line items (e.g., buried cable—metallic). An item of plant identifier (IPID) data element 632 that is unique to each of the communications infrastructure components may be assigned for each component in the communications infrastructure. Sheet data elements 634 may identify an engineering sheet on which the communications infrastructure is shown.

Task type data elements 636 that are assigned by an engineer using the engineering work order software tool may be defined for an operation to be performed on the communications infrastructure. The task type data elements 636 may be assigned to “remove,” “place,” “splice,” “modify,” etc. Labor code data elements 638 may be tied to the account code data elements 622. For example, placing buried plant may have account code ‘242311’ and a labor code associated with that account code may be ‘45C’. If a construction supervisor decides that the job should be aerial cable, then the engineer may change the account code to ‘242111’ that translates to labor code ‘2C’. The task type and labor code combination may thereby be used to define a list of applicable unit item codes that may be selectable by a user in making the cost estimate.

Unit type data elements 639 define how each communications infrastructure element is to be maintained (e.g., “buried”). Unit item data elements 640 and work description data elements 642 may be selectable using graphical user interface elements, such as pull-down menus. As previously described, the unit item data element 640 may be selectable from a list that is limited by a combination of task type data element and labor code data element.

As shown in FIG. 6B, a pull-down menu 644 in the unit item data elements 640 may be provided for a user to select a particular unit item (e.g., ‘624700’). The list of unit items shown in the pull-down menu 644 may be defined by a combination of task type (e.g., ‘place’) and labor code (e.g., ‘45C’). As shown in FIG. 6C, a combination of the task type data element and labor code data element may be used to define a selectable list of work description data elements 646 that may be displayed in a pull-down menu 648 for selection by an engineer using the cost estimation tool.

Continuing with FIG. 6A, based on the unit data element 626, quantity data element 628, unit item data element 640, and optionally, other data elements (e.g., task type data element 636 and labor code data element 638), price data elements 650 may be determined, where the price is based on a unit of measure. Total price data elements 652 may be determined by multiplying quantity data element 628 by price data elements 650. A notes data elements 654 may be available for an engineer to enter notes for each of the line items 620. The cost estimation tool may enable the user to save the data set that includes the line items 620 in a database or other data repository for use in comparing against invoices that are later received from the selected supplier 612. In one embodiment, a subset of the data set including the line item 620 that does not include proprietary information, such as the price data element 650 and total price data element 652, may be used to provide a subset view of data so that the field engineer merely sees information associated with performing a work project.

With regard to FIG. 7, a screenshot of an illustrative graphical user interface 700 showing a summary of work activities is shown. The work activity summary may be that of a single work activity or work authorization (e.g., ‘39243514 ’) and show a list of account codes 702 (e.g., ‘242311,’ ‘342315,’ ‘642312’), where each of the account codes represent a different account to which the line items or communications infrastructure are assigned. In one embodiment, account code ‘242311’ is a capital account column 704a, account code ‘342315’ is a removal account or expense account column 704b, and account code ‘642312’ is a maintenance account column 704c. A removal account is one where a utility pole is taken down, a cabinet is removed, or a cable is removed, for example. A maintenance account may be assigned when neither removal nor replacement is performed, but rather when a communications infrastructure component, such as a cable, requires modification, such as stenciling, splicing, or otherwise. An accounts total row 706 may be used to total each of the account columns 704a-704c and unit item total column 708. The labor costs are summarized by the cost estimation tool for a user to make final estimates before initiating a work project.

With regard to FIG. 8, a screenshot of an illustrative engineering construction portal graphical user interface 800 is shown. The graphical user interface 800 shows an IPID checklist that lists a list of IPID numbers 802, feature types 804, actions 806, resource types 808 (contractors or workers who are performing work on the communications infrastructure), and status data elements 810. The graphical user interface 800 may be accessible by an engineer or other user via a communications network, such as the Internet, so that the engineer may access the IPID checklist or other information generated by the cost estimation tool or engineering work order software tool.

With regard to FIG. 9, an illustrative spreadsheet 900 is shown that includes data from the cost estimation tool without any confidential information, such as pricing. The data may be associated with a particular work authorization number 902 (e.g., ‘39243514’) and include each line item associated with that work authorization. An engineer may utilize the spreadsheet 900 in the field for performing a work project. The spreadsheet 900 may be exported from the cost estimation tool.

With regard to FIG. 10, a flowchart of an illustrative process 1000 for performing cost estimation in performing a work project on communications infrastructure is shown. The process 1000 starts at step 1002, where a first data record generated by a first software tool may be accessed. The first data record may include data that specifies a work project on communications infrastructure. The first software tool may be an engineering work order software tool that enables an engineer to draw communications infrastructure and associate attributes with the communications infrastructure. At step 1004, a second data record utilized by a second software tool utilized in the data of the first data record may be populated. In one embodiment, the population of the second data record may be performed automatically. At step 1006, a data set that is related to a combination of the first data element and a second data element of the first data record may be accessed. The data set may include cost estimation generated by the second software tool, which may be a cost estimation tool. At step 1008, the data set may be presented to the user in a selectable format to enable the user to select a third data element from the presented data set. The third data element may be used to estimate a cost for performing the work project. In one embodiment, the third data element may be a unit item that the cost estimation tool uses to determine an estimate for cost of the communications infrastructure. At step 1010, a cost estimate based on the third data element may be generated by the second software tool. The cost estimate may be produced on a per unit basis, such as a per foot estimate. For example, if one-hundred feet of cable is to be placed and the cost for each foot is negotiated contractually with a contractor to be $3.55 per foot, then the cost estimate is $355. Variables may be available based on actual installation of the cable, such as hitting rock, which may increase the cost per foot to be increased to $15.22 per foot, for example, depending on the contract. At step 1012, the cost estimate may be presented to the user using the second software tool. In one embodiment, the generation and presentation steps may be performed automatically, such as in the same or similar manner as performed on a spreadsheet program. A subset of the second data record that does not include the cost estimate may be generated for field engineers to use for performing the work project.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed:

1. A method for providing cost estimation in performing a work project on communications infrastructure, said method comprising:
accessing a first data record generated by a first software tool, the first data record including data that specifies a work project on communications infrastructure;
populating a second data record utilized by a second software tool utilizing the data of the first data record;
accessing a data set that is related to a combination of a first data element and a second data element of the first data record;
presenting, using the second software tool, the data set to a user in a selectable format to enable the user to select a third data element from the presented data set, the third data element being used to estimate a cost for performing the work project;
generating, using the second software tool, a cost estimate based on the third data element; and
presenting, using the second software tool, the cost estimate to the user.

2. The method according to claim 1, further comprising generating, by the second software tool, a subset of the second data record that does not include the cost estimate for field engineers to use for performing the work project.

3. The method according to claim 1, wherein accessing the first data record includes accessing the first data record as generated by an engineering work order software tool.

4. The method according to claim 1, wherein populating the second data record is performed automatically.

5. The method according to claim 1, further comprising making at least a portion of the second data record available to a third software tool that is accessible via a communications network.

6. The method according to claim 1, wherein accessing the data set includes accessing a list of unit items that are available for a combination of the first and second data elements.

7. The method according to claim 6, wherein the first and second data elements are task type and labor code data elements.

8. The method according to claim 1, wherein populating the second data record includes populating the second data record with unit, quantity, and material description data elements that are utilized in generating the cost estimate.

9. The method according to claim 1, further comprising:
accessing, by the second software tool, a third data set including contract terms of a contractor available to perform the work project; and
wherein generating, by the second software tool, the cost estimate includes using the contract terms of the contractor.

10. The method according to claim 9, further comprising selecting the contractor from among multiple contractors that have data records selectable for use in generating the cost estimate.

11. A system for providing cost estimation in performing a work project on communications infrastructure, said system comprising:
a first software tool configured to enable a first user to draw communications system infrastructure and create a first data record that includes a plurality of attributes associated with the drawn communications system infrastructure; and
a second software tool configured to import the first data record and populate a second data record, said second software tool further configured to enable a second user to select a data element from a data set that relates to first and second data elements of the first data record that is specified by the first user, said second software tool further configured to generate a cost estimate based on the selected data element and to present the cost estimate to the second user.

12. The system according to claim 11, wherein said second software tool is further configured to generate a subset of the second data record that does not include the cost estimate, the subset being used by field engineers for performing the work project.

13. The system according to claim 11, wherein said first software tool is an engineering work order software tool.

14. The system according to claim 11, wherein said second software tool is configured to auto-populate the second data record with data elements of the first data record.

15. The system according to claim 11, further comprising a third software tool that is configured to be accessed via a communications network and enable a user to access the second data record.

16. The system according to claim 11, wherein the data set includes a list of unit items that are available for a combination of the first and second data elements.

17. The system according to claim 16, wherein the first and second data elements are task type and labor code data elements.

18. The system according to claim 11, wherein said second software tool is configured to populate the second data record with unit, quantity, and material description data elements that are utilized in generating the cost estimate.

19. The system according to claim 11, further comprising a third data set including contract terms of a contractor available to perform the work project, and wherein said second software tool uses the contract terms of the contractor to generate the cost estimate.

20. The system according to claim 19, wherein said second software tool is further configured to enable the second user to select the contractor from among multiple contractors that have data records selectable for use in generating the cost estimate.
